(19) United States
(12) Patent Application Publication
(10) Pub. No.: US 2006/0090837 A1
(43) Pub. Date: May 4, 2006

(54) Process for manufacturing a flat wrapping material

(76) Inventors: Cheng-Kang Kao, Taipei (TW); Su-Chen Chen, Taipei (TW)

Correspondence Address: BUCKNAM AND ARCHER, 1077 NORTHERN BOULEVARD, ROSLYN, NY, 11576, US

(21) Appl. No.: 11/057,820

(22) Filed: Feb. 14, 2005

(30) Foreign Application Priority Data
Nov. 4, 2004 (TW) 093133632

(51) Int. Cl. B31C 1/00; H01F 41/12; F16J 15/20

(52) U.S. Cl. 156/184; 156/185; 156/194

(57) ABSTRACT

A process for manufacturing a flat wrapping material includes the steps of (a) providing a circular roll of wrapping material, (b) compressing the circular roll of wrapping material into a flattened manner where the inner diameter of the circular roll of wrapping material is flattened to form two closely attached symmetric planes, and (c) applying an adhesive on the two closely attached symmetric planes to fixedly secure the two closely attached symmetric planes together.

### BACKGROUND OF THE INVENTION

1. Field of the Invention

The present invention relates to a process for manufacturing a flat wrapping material composed of adhesive tape, plastic film, cloth, metal foil, compsite material film, or paper, and more particularly, to such a flat wrapping material manufacturing process, which greatly saves operating time and reduces the manufacturing cost.

2. Description of the Related Art

Flat wrapping materials such as adhesive tape, plastic film, cloth, metal foil, composite material film, or paper, are commonly provided in the form of a roll. These wrapping materials may also be provided in a flat form convenient for carrying in the pocket, bag, or pack.

A flat roll of adhesive tape manufacturing process is known comprising: providing a flat tube of interfacial material; inserting a spindle into the flat tube of interfacial material to have a sheet of adhesive material be wound round the flat tube of interfacial material to form with the interfacial material the flat roll of adhesive tape. The flat roll of adhesive tape, as shown in FIG. 1, comprises a roll of adhesive tape 11 and a rectangular supporting tube 12 supporting the roll of adhesive tape 11. The rectangular supporting tube 12 can be a plastic tube or stiff paper tube. In comparison to a conventional circular adhesive tape manufacturing process, this method requires relatively longer operating time. Further, the finished adhesive tape has relatively lower transmittance, and air bubbles may be formed in between adhesive layers.

U.S. Pat. No. 6,224,705 discloses a process for manufacturing a flat adhesive tape, which comprises (1) providing a stiff interfacial sheet having a flat and solid form; (2) surrounding the stiff interfacial sheet with a plurality of adhesive layers so as to form a roll of the adhesive layers with the stiff interfacial sheet positioned on a symmetric plane of the roll; and (3) compressing the roll to form the flat adhesive tape. The stiff interfacial sheet can have a length slightly longer than a half-length of an innermost circumference of the roll of the adhesive layers. A layer of high adhesion material containing uncured high cross-linking epoxy resin or uncured high cross-linking cyanoacrylate resin can be provided between the stiff interfacial sheet and the adhesive layers. After compressing the roll of the adhesive layers, the high adhesion material is cured to form the flat adhesive tape. US. Pat. No. 6,500,290 discloses a similar process for manufacturing a flat adhesive tape, which comprises the steps of: providing a flat stiff interfacial layer having a symmetric plane; deposing a high adhesion material on the interfacial layer, wherein the high adhesion material is one selected from a group consisting of high glass transition temperature polymeric material, thermoset material, hot melt material, and ultra-violet adhesive material; and surrounding the symmetric plane of the stiff interfacial layer and the high adhesive material thereon with an adhesive layer in a multi-layer manner to form a roll of adhesive tape; and flattening the roll of the adhesive tape.

The aforesaid U.S. Pat. Nos. 6,224,705 and 6,500,290 are inventions of the present inventor. These two patents are incorporated herein by reference. In order to reduce the manufacturing cost and save the manufacturing time, the inventor invented the present invention after a long time study and a series of trials. The flat wrapping material manufacturing process of the present invention is practical for manufacturing flat roll of adhesive tape as well as flat roll of any of a variety of other materials including plastic film, cloth, metal foil, compoosite material, and paper.

### SUMMARY OF THE INVENTION

The present invention has been accomplished under the circumstances in view. According to one embodiment of the present invention, the process for manufacturing a flat wrapping material comprises the steps of process for manufacturing a flat wrapping material comprising the steps of: (a) providing a circular roll of wrapping material having a circular stub tube of interfacial material supported therein, (b) compressing the circular roll of wrapping material into a flattened manner where the inner diameter of the circular stub tube of interfacial material is flattened to form two closely attached symmetric planes, and (c) applying an adhesive to the two closely attached symmetric planes to fixedly secure the two closely attached symmetric planes together.

According to a second embodiment of the present invention, the process for manufacturing a flat wrapping material comprises the steps of: (a) providing a circular roll of wrapping material, (b) compressing the circular roll of wrapping material into a flattened manner where the inner diameter of the circular roll of wrapping material is flattened to form two closely attached symmetric planes, and (c) applying an adhesive on the two closely attached symmetric planes to fixedly secure the two closely attached symmetric planes together.

According to a third embodiment of the present invention, the process for manufacturing a flat wrapping material comprises the steps of: (a) providing a circular roll of wrapping material. (b) inserting a stiff interfacial material into the inner diameter of the circular roll of wrapping material, (c) compressing the circular roll of wrapping material into a flattened manner where the inner diameter of the circular roll of wrapping material is flattened to form two symmetric planes closely attached to two opposite sides of the stiff interfacial material, and (d) applying a cross-linked adhesive on the two symmetric planes to fixedly secure the two symmetric planes to the two opposite sides of the stiff interfacial material.

According to a fourth embodiment of the present invention, the process for manufacturing a flat wrapping material comprises the steps of: (a) providing a first circular roll of wrapping material, (b) inserting a stiff interfacial material through the inner diameter of the first circular roll of wrapping material, (c) compressing the first circular roll of wrapping material into a flattened manner where the inner diameter of the first circular roll of wrapping material is flattened to form two symmetric planes closely attached to two opposite sides of the stiff interfacial material, (d) applying a cross-linked adhesive on the two symmetric planes of the first circular roll of wrapping material to fixedly secure the two symmetric planes of the first circular roll of wrapping material to the two opposite sides of the stiff interfacial material, (e) providing a second circular roll of wrapping material, (f) inserting the stiff interfacial material through the inner diameter of the second circular roll of wrapping material, (g) compressing the second circular roll of wrapping material into a flattened manner where the inner diameter of the second circular roll of wrapping material is flattened to form two symmetric planes closely attached to two opposite sides of the stiff interfacial material, (h) applying a cross-linked adhesive on the two symmetric planes of the second circular roll of wrapping material to fixedly secure the two symmetric planes of the second circular roll of wrapping material to the two opposite sides of the stiff interfacial material, (i) providing a third circular roll of wrapping material, (j) inserting a stiff interfacial material through the inner diameter of the third circular roll of wrapping material, (k) compressing the third circular roll of wrapping material into a flattened manner where the inner diameter of the third circular roll of wrapping material is flattened to form two symmetric planes closely attached to two opposite sides of the stiff interfacial material, and (1) applying a cross-linked adhesive on the two symmetric planes of the third circular roll of wrapping material to fixedly secure the two symmetric planes of the third circular roll of wrapping material to the two opposite sides of the stiff interfacial material.

### BRIEF DESCRIPTION OF THE DRAWINGS

FIG. 1 is an elevational view of a flat roll of adhesive tape according to the prior art.

FIG. 2 is a schematic drawing showing a flat wrapping material manufacturing flow according to a first embodiment of the present invention.

FIG. 3 is a schematic drawing showing a flat wrapping material manufacturing flow according to a second embodiment of the present invention.

FIG. 4 is a schematic drawing showing a flat wrapping material manufacturing flow according to a third embodiment of the present invention.

FIG. 5 illustrates a flat wrapping material made based on the process of FIG. 4 with the stiff interfacial material protruded over one side of the flat wrapping material.

FIG. 6 illustrates a flat wrapping material made based on the process of FIG. 4 with three rolls of wrapping material supported on one single stiff interfacial material.

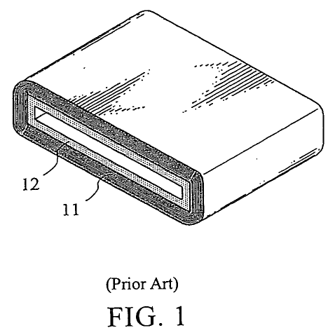

### DETAILED DESCRIPTION OF THE PREFERRED EMBODIMENT

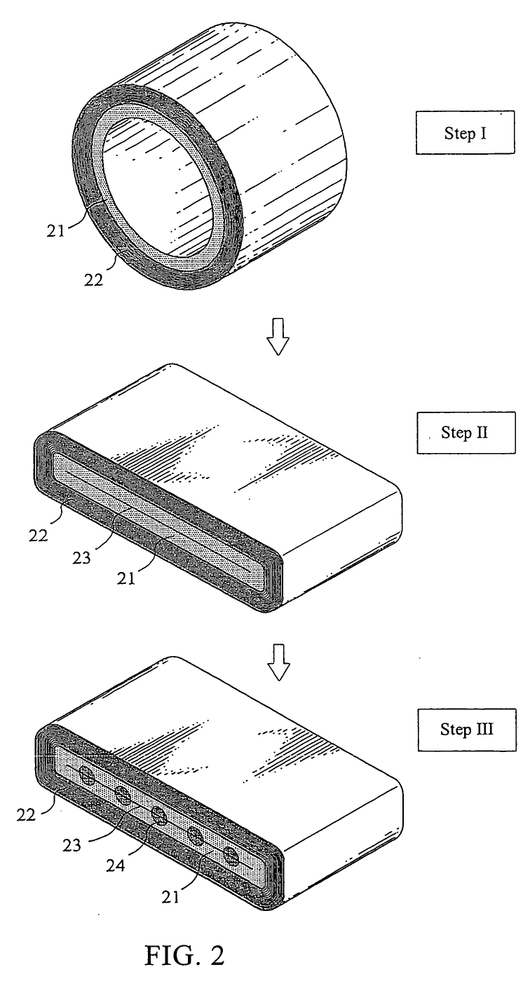

Referring to FIG. 2, a flat wrapping material manufacturing process in accordance with the first embodiment of the present invention is shown comprising the steps of: (1) providing a circular roll of wrapping material 22 having a circular stub tube of interfacial material (paper or plastics) 21 supported therein, wherein the wrapping material for the circular roll of wrapping material 22 can be one selected from a group consisting of adhesive material, plastic film material, cloth, metal foil, composite film material, and paper (see Step I in FIG. 2); (2) compressing the circular roll of wrapping material into a flattened manner where the inner diameter of the circular stub tube of interfacial material 21 is flattened to form two closely attached symmetric planes 23 (see Step II in FIG. 2); (3) applying an adhesive 24, for example, cyanoacrylate or epoxy resin on the two closely attached symmetric planes 23 to fixedly secure the two closely attached symmetric planes 23 together (see Step III in FIG. 2).

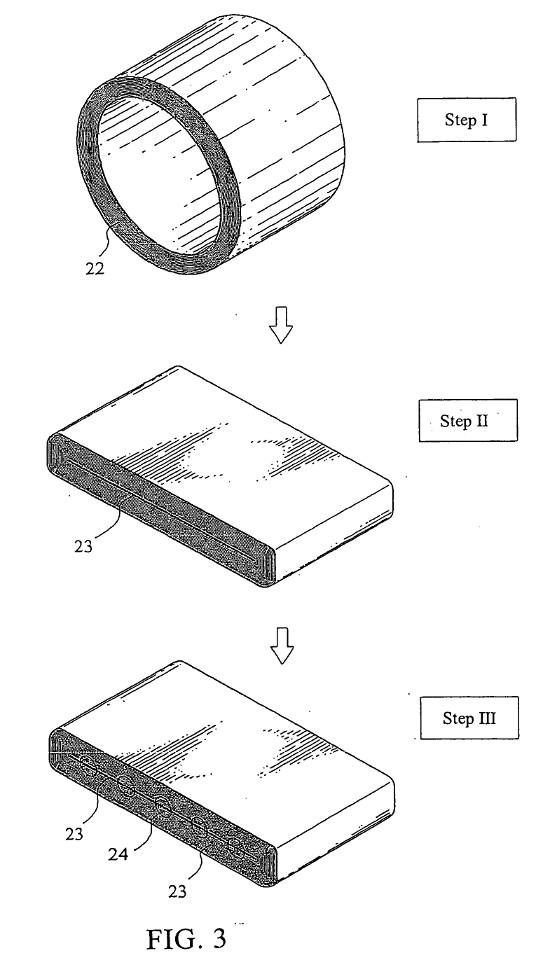

Referring to FIG. 3, a flat wrapping material manufacturing process in accordance with the second embodiment of the present invention is shown comprising the steps of: (1) providing a circular roll of wrapping material 22 selected from a group consisting of cross-linked adhesive material, plastic film material, cloth, metal foil, composite film material, and paper (see Step I in FIG. 3); (2) compressing the circular roll of wrapping material 22 into a flattened manner where the inner diameter of the circular roll of wrapping material 22 is flattened to form two closely attached symmetric planes 23 (see Step II in FIG. 3); (3) applying a cross-linked adhesive 24, for example, cyanoacrylate or epoxy resin on the two closely attached symmetric planes 23 to fixedly secure the two closely attached symmetric planes 23 together (see Step III in FIG. 3).

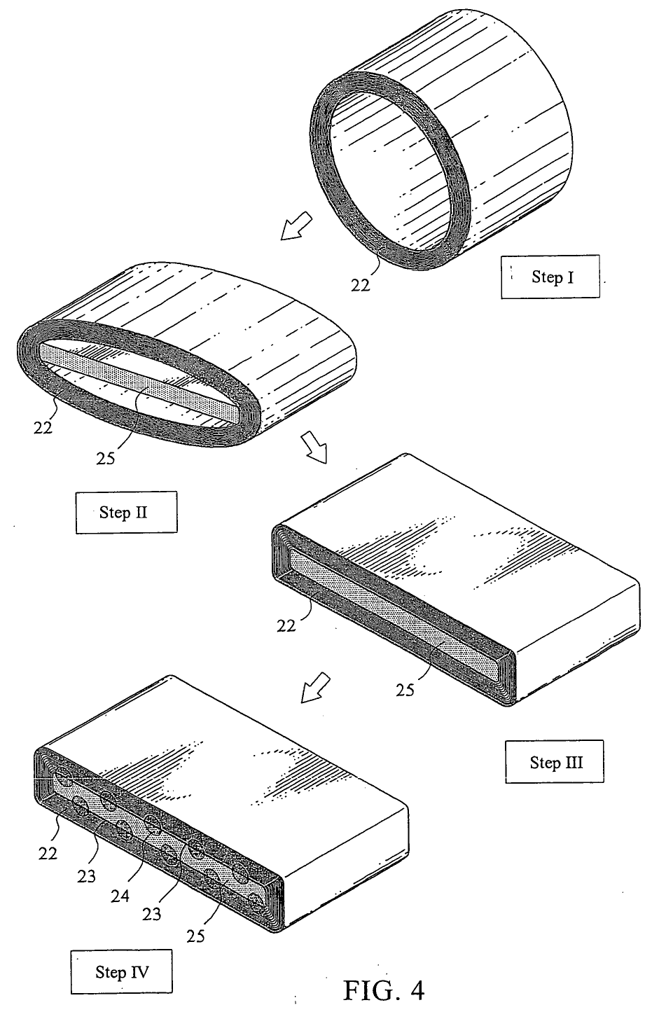

Referring to FIG. 4, a flat wrapping material manufacturing process in accordance with the third embodiment of the present invention is shown comprising the steps of: (1) providing a circular roll of wrapping material 22 selected from a group consisting of adhesive material, plastic film material, cloth, metal foil, composite film material, and paper (see Step I in FIG. 4); (2) inserting a stiff interfacial material 25, for example, a stiff paper or plastic material into the inner diameter of the circular roll of wrapping material 22 (see Step II in FIG. 4); (3) compressing the circular roll of wrapping material 22 into a flattened manner where the inner diameter of the circular roll of wrapping material 22 is flattened to form two symmetric planes 23 closely attached to two opposite sides of the stiff interfacial material 25 (see Step III in FIG. 4); (4) applying a cross-linked adhesive 24, for example, cyanoacrylate or epoxy resin on the two closely attached symmetric planes 23 to fixedly secure the two symmetric planes 23 to the two opposite sides of the stiff interfacial material 25 (see Step IV in FIG. 4).

In FIGS. 2-4, the cross-linked adhesive 24 is applied on the symmetric planes 23 at spots. In order to enhance the tightness of the connection, the cross-linked adhesive 24 can be applied on the symmetric planes 23 to form a sealing line at each side.

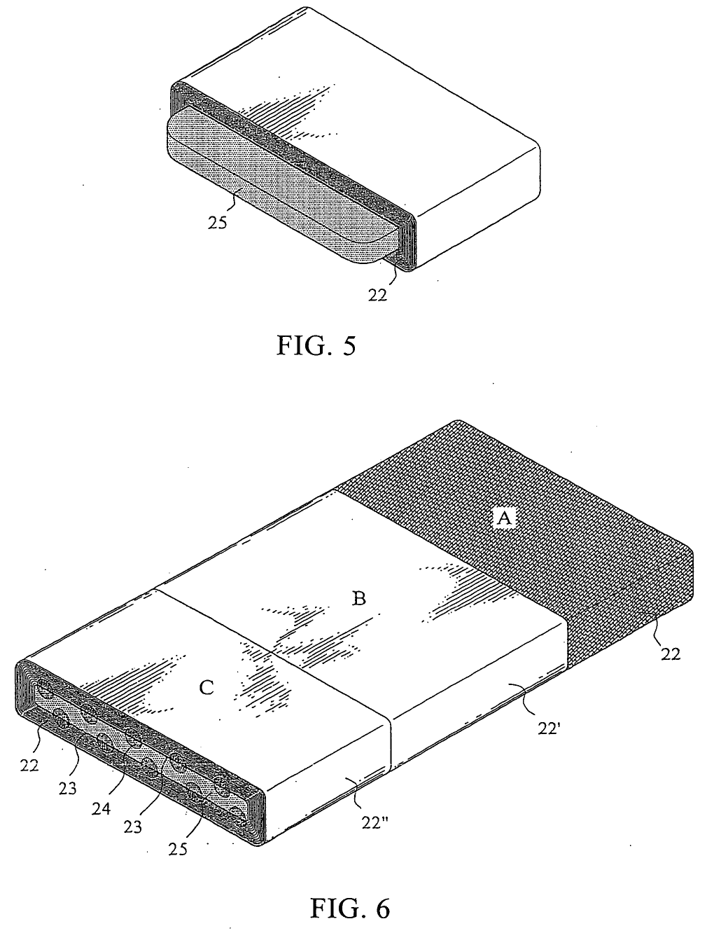

Referring to FIG. 5 and FIG. 4 again, the stiff interfacial material 25 can be made having a width greater than the width of the circular roll of wrapping material 22 such that the stiff interfacial material 25 has a part protruding over one side of the flat wrapping material for printing advertising words or patterns.

FIG. 6 shows a flat wrapping material made based on the process of FIG. 4. According to this alternate form, the stiff interfacial material 25 is inserted into a first roll of wrapping material 22, a second roll of wrapping material 22′ and a third roll of wrapping material 22″. These three rolls of wrapping material 22;22′;22″ can have different widths and can be formed of different materials.

Although particular embodiments of the invention have been described in detail for purposes of illustration, various modifications and enhancements may be made without departing from the spirit and scope of the invention.

What the invention claimed is:

1. A process for manufacturing a flat wrapping material comprising the steps of:
(a) providing a circular roll of wrapping material having a circular stub tube of interfacial material supported therein;
(b) compressing said circular roll of wrapping material into a flattened manner where the inner diameter of said circular stub tube of interfacial material is flattened to form two closely attached symmetric planes; and
(c) applying an adhesive to said two closely attached symmetric planes to fixedly secure said two closely attached symmetric planes together.

2. The process for manufacturing a flat wrapping material as claimed in claim 1, wherein said circular roll of wrapping material is selected from a group consisting of cross-linked adhesive material, plastic film material, cloth, metal foil, composite film material and paper.

3. The process for manufacturing a flat wrapping material as claimed in claim 1, wherein said circular stub tube of interfacial material is selected from a group consisting of paper and plastics.

4. The process for manufacturing a flat wrapping material as claimed in claim 1, wherein said adhesive is applied on said two closely attached symmetric planes at spots.

5. The process for manufacturing a flat wrapping material as claimed in claim 1, wherein said adhesive is applied on said two closely attached symmetric planes at each side in the form of a sealing line.

6. A process for manufacturing a flat wrapping material comprising the steps of:
(a) providing a circular roll of wrapping material;
(b) compressing said circular roll of wrapping material into a flattened manner where the inner diameter of said circular roll of wrapping material is flattened to form two closely attached symmetric planes; and
(c) applying an adhesive on said two closely attached symmetric planes to fixedly secure said two closely attached symmetric planes together.

7. The process for manufacturing a flat wrapping material as claimed in claim 6, wherein said circular roll of wrapping material is selected from a group consisting of cross-linked adhesive material, plastic film material, cloth, metal foil, composite film material and paper.

8. The process for manufacturing a flat wrapping material as claimed in claim 6, wherein said adhesive is applied on said two closely attached symmetric planes at spots.

9. The process for manufacturing a flat wrapping material as claimed in claim 6, wherein said adhesive is applied on said two closely attached symmetric planes at each side in the form of a sealing line.

10. A process for manufacturing a flat wrapping material comprising the steps of:
(a) providing a circular roll of wrapping material;
(b) inserting a stiff interfacial material into the inner diameter of said circular roll of wrapping material;
(c) compressing said circular roll of wrapping material into a flattened manner where the inner diameter of said circular roll of wrapping material is flattened to form two symmetric planes closely attached to two opposite sides of said stiff interfacial material; and
(d) applying a cross-linked adhesive on said two symmetric planes to fixedly secure said two symmetric planes to the two opposite sides of said stiff interfacial material.

11. The process for manufacturing a flat wrapping material as claimed in claim 10, wherein said circular roll of wrapping material is selected from a group consisting of cross-linked adhesive material, plastic film material, cloth, metal foil, composite film material and paper.

12. The process for manufacturing a flat wrapping material as claimed in claim 10, wherein said adhesive is applied on said two closely attached symmetric planes at spots.

13. The process for manufacturing a flat wrapping material as claimed in claim 10, wherein said adhesive is applied on said two closely attached symmetric planes at each side in the form of a sealing line.

14. The process for manufacturing a flat wrapping material as claimed in claim 10, wherein said stiff interfacial material has a width not less than the width of said circular roll of wrapping material.

15. The process for manufacturing a flat wrapping material as claimed in claim 10, wherein said stiff interfacial material has a length not greater than one half of the circumference of the inner diameter of said circular roll of wrapping material.

16. A process for manufacturing a flat wrapping material comprising the steps of:
(a) providing a first circular roll of wrapping material;
(b) inserting a stiff interfacial material through the inner diameter of said first circular roll of wrapping material;
(c) compressing said first circular roll of wrapping material into a flattened manner where the inner diameter of said first circular roll of wrapping material is flattened to form two symmetric planes closely attached to two opposite sides of said stiff interfacial material;
(d) applying a cross-linked adhesive on the two symmetric planes of said first circular roll of wrapping material to fixedly secure the two symmetric planes of said first circular roll of wrapping material to the two opposite sides of said stiff interfacial material;
(e) providing a second circular roll of wrapping material;
(f) inserting said stiff interfacial material through the inner diameter of said second circular roll of wrapping material;
(g) compressing said second circular roll of wrapping material into a flattened manner where the inner diameter of said second circular roll of wrapping material is flattened to form two symmetric planes closely attached to two opposite sides of said stiff interfacial material;
(h) applying a cross-linked adhesive on the two symmetric planes of said second circular roll of wrapping material to fixedly secure the two symmetric planes of said second circular roll of wrapping material to the two opposite sides of said stiff interfacial material;
(i) providing a third circular roll of wrapping material;
(j) inserting a stiff interfacial material through the inner diameter of said third circular roll of wrapping material;
(k) compressing said third circular roll of wrapping material into a flattened manner where the inner diameter of said third circular roll of wrapping material is flattened to form two symmetric planes closely attached to two opposite sides of said stiff interfacial material; and
(l) applying a cross-linked adhesive on the two symmetric planes of said third circular roll of wrapping material to fixedly secure the two symmetric planes of said third circular roll of wrapping material to the two opposite sides of said stiff interfacial material.

17. The process for manufacturing a flat wrapping material as claimed in claim 16, wherein said first circular roll of wrapping material and said second circular roll of wrapping material and said third circular roll of wrapping material are prepared from different materials.

18. The process for manufacturing a flat wrapping material as claimed in claim 17, wherein said first circular roll of wrapping material and said second circular roll of wrapping material and said third circular roll of wrapping material are selected from a group consisting of cross-linked adhesive material, plastic film material, cloth, metal foil, composite film material and paper.

19. The process for manufacturing a flat wrapping material as claimed in claim 16, wherein said first circular roll of wrapping material and said second circular roll of wrapping material and said third circular roll of wrapping material have different widths.

20. The process for manufacturing a flat wrapping material as claimed in claim 16 further comprising the steps of providing at least one fourth circular roll of wrapping material and compressing said at least one fourth circular roll of wrapping material and securing said at least one fourth circular roll of wrapping material to said stiff interfacial material in same way.
